(19) United States
(12) Patent Application Publication
(10) Pub. No.: US 2017/0178189 A1
(43) Pub. Date: Jun. 22, 2017

(54) Systems and Methods for Use in Directing Product Offer Content to Consumers

(71) Applicant: MASTERCARD INTERNATIONAL INCORPORATED, Purchase, NY (US)

(72) Inventors: Po Hu, Norwalk, CT (US); Henry Weinberger, New York, NY (US); Shen Xi Meng, Millwood, NY (US); Jean-Pierre Gerard, Croton-On-Hudson, NY (US)

(21) Appl. No.: 14/978,706

(22) Filed: Dec. 22, 2015

(51) Int. Cl. G06Q 30/02; H04W 4/02

(52) U.S. Cl. CPC G06Q 30/0259; H04W 4/023; G06Q 30/0254; G06Q 30/0255

(57) ABSTRACT

Exemplary systems and methods are provided for directing offer content to consumers at communication devices, while the consumers are at merchants. An exemplary method includes detecting an application identifier associated with a communication device at or near a merchant, and receiving signal strength records from the communication device indicative of signal strengths for wireless networking devices at a given time and associated with the application identifier. The method also includes accessing a zone map for the merchant that includes different zones each defining a position of at least one product, and plotting a path of the communication device, per given time, relative to the zone map. The method further includes displaying an offer for a product to the communication device, based on the path of the consumer through the merchant, along with other factors such as historical behavior patterns of the consumer, similar patterns from other consumers, etc.

### FIELD

The present disclosure generally relates to systems and methods for use in directing product offer content, specific to products and/or merchants, to consumers while the consumers are at merchant locations or within general regions of such merchant locations (e.g., within shopping regions having multiple merchants, within single merchant stores, etc.).

### BACKGROUND

This section provides background information related to the present disclosure which is not necessarily prior art.

Products (e.g., goods, services, etc.) are known to be offered for sale, and to be sold, by merchants. Consumers often shop at merchants based on the products offered by the merchants, special offers provided from the merchants, locations of the merchants relative to the consumers, convenience of the merchants, etc. Often, product purchases are accompanied with the presentation of coupons or offers, by which the prices associated with the products may be reduced or the quantities available may be increased. Coupons, for example, are known to be circulated through a number of mechanisms, including periodicals, mailers, and websites. In addition, merchants have employed a number of different methods to direct coupons to consumers, who are more likely to use the coupons. For example, merchants are known to direct coupons to consumers registered to loyalty programs and/or consumers who have previously purchased products at the merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in directing offer content to a consumer based on, at least in part, a location of the consumer within a merchant location;

FIG. 2 is a block diagram of a computing device that may be used in the exemplary system of FIG. 1;

FIG. 3 is an exemplary method, which may be used in connection with the system of FIG. 1, for directing offer content to a consumer at a merchant location; and

FIG. 4 is a block diagram of another exemplary system of the present disclosure suitable for use in directing offer content to a consumer based on, at least in part, a location of the consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Merchants employ a number of different methods to direct purchase offers to consumers, to entice the consumers to purchase various products from the merchants. For example, merchants are known to support loyalty programs, in which consumers register with the merchants, and in return receive offers for discounts or specials, etc., available from the merchants. Outside of such loyalty programs, merchants also often direct offers to consumers that have previously purchased products at the merchants. However, in both cases, such offers are typically received by the consumers after purchases have been made or while the consumers are involved in other activities. And, as can be appreciated, offers received by the consumers outside of purchasing activities typically have less influence and/or impact on the customers' purchasing behaviors. In fact, the influence and/or impact of the offers significantly reduces as time lag increases between receiving the offers and the consumers' next purchasing activities. What's more, while sales people associated with merchants can help consumers when they are at the merchants, and potentially direct offers to the consumers, the sales people often know little about the consumers' purchasing tendencies and, due to time and/or staffing constraints, are not able to engage all consumers within the merchants.

Uniquely, the systems and methods herein operate to direct offers to consumers while the consumers are actively shopping at merchants or are at least in the general vicinity of the merchants, so that the offers are received by the consumers when the consumers are ready to purchase products or can easily access the corresponding merchants. In so doing, the offers are delivered to, and received by, the consumers when the consumers are ready to make purchasing decisions. Moreover, the systems and methods herein operate to tailor the offers to the consumers by taking into account transaction history for the consumers, present location data, and/or consumer paths within merchants (either current or historical), so that offers may be timely delivered to the consumers during shopping experiences.

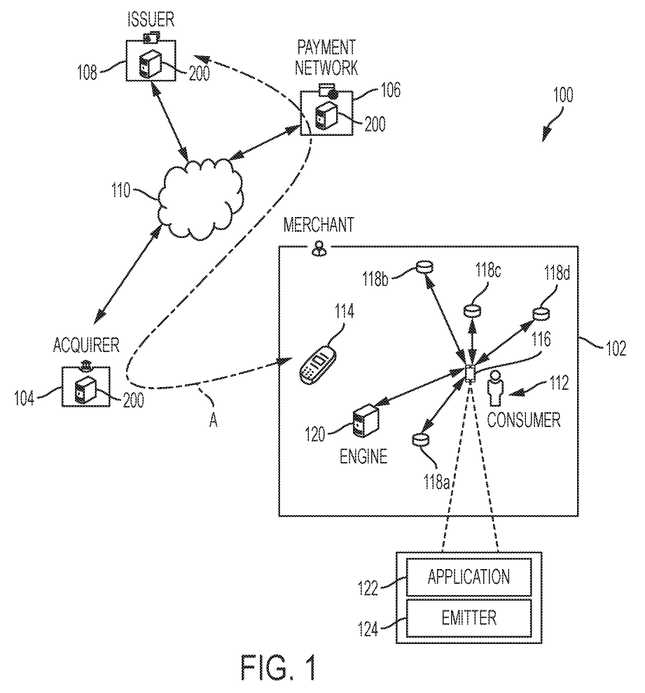

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on locations and/or arrangements of routers, merchants, shopping regions, etc. and/or on particular operations/processes used to determine locations in the system 100 (e.g., Wi-Fi operations, global position system (GPS) operations, etc.).

Referring to FIG. 1, the system 100 generally includes a merchant 102, an acquirer 104, a payment network 106, and an issuer 108, each coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network through which the merchant 102 and the acquirer 104 may communicate (e.g., via a website or via internet-based applications, etc.).

In the system 100, the merchant 102 offers products (e.g., goods and/or services, etc.) for sale to consumers, such as consumer 112. In FIG. 1, the consumer 112 is shown present at the merchant 102, to make one or more purchases of products, via a payment account associated with the consumer 112. The merchant 102 includes a point of sale (POS) terminal 114, which is employed to interact with the consumer 112, and in particular, a payment device associated with the consumer's payment account, to facilitate a payment account transaction.

For example, the consumer 112 may initiate a transaction with the merchant 102 by presenting the payment device (e.g., a credit card, a debit card, a fob, a smartcard, a web-based e-wallet application, etc.) to the merchant 102, at the POS terminal 114. In turn, the POS terminal 114 (broadly, the merchant 102) receives payment account information for the consumer 112 from the payment device and communicates an authorization request (e.g., including a payment account number and an amount of the purchase, etc.) to the acquirer 104 to determine whether the payment account is in good standing and whether there is sufficient finds and/or credit to cover the transaction. The authorization request is transmitted along path A in the system 100, as referenced in FIG. 1. The acquirer 104 communicates the authorization request with the issuer 108, through the payment network 106, such as, for example, through MasterCard®, VISA®, Discover®, American Express®, etc. In turn, if approved, an authorization reply (indicating the approval of the transaction) is transmitted back from the issuer 108 to the merchant 102, along path A, thereby permitting the merchant 102 to complete the transaction. The transaction is later cleared and/or settled by and between the merchant 102, the acquirer 104, and the issuer 108. If declined, however, the authorization reply (indicating a decline of the transaction) is provided back to the merchant 102, along the path A, thereby permitting the merchant 102 to halt or terminate the transaction.

Transaction data is generated, collected, and stored as part of the above exemplary interactions among the merchant 102, the acquirer 104, the payment network 106, the issuer 108, and the consumer 112. The transaction data includes a plurality of transaction records, one for each transaction, or attempted transaction. The transaction records, in this exemplary embodiment, are stored at least by the payment network 106 (e.g., in a data structure associated with the payment network 106, etc.). Additionally, or alternatively, the merchant 102, the acquirer 104, and/or the issuer 108 may store the transaction records in corresponding data structures, or transaction records may be transmitted between parts of system 100. The transaction records may include, for example, payment account numbers, amounts of the transactions, merchant IDs, and dates/times of the transactions. It should be appreciated that more or less information related to transactions, as part of either authorization or clearing and/or settling, may be included in transaction records and stored within the system 100, at the merchant 102, the acquirer 104, the payment network 106 and/or the issuer 108.

In the embodiments herein, consumers (e.g., consumer 112, etc.) involved in the different transactions are prompted to agree to legal terms associated with their payment accounts, for example, during enrollment in their accounts, etc. In so doing, the consumers voluntarily agree, for example, to allow merchants, issuers, payment networks, etc., to use transaction data generated and/or collected during enrollment and/or in connection with processing the transactions, for subsequent use in general, and as described herein.

As also shown in FIG. 1, the consumer 112 is associated with a communication device 116, and in particular, a portable communication device (e.g., a smartphone, a tablet, etc.). The communication device 116 generally moves with the consumer 112, as the consumer 112 moves from location to location, for example, within the merchant 102, etc.

The consumer's communication device 116 is configured, via an internet-based application 122 (e.g., installed on the communication device 116 or otherwise accessible by the communication device 116, etc.), to perform one or more of the operations described herein. The internet-based application 122 may be a standalone application, or the operations herein may be incorporated into another internet-based application such as, for example, an electronic wallet application (or e-wallet such as, for example, MasterPass® from MasterCard, Apple Pay® from Apple, PayWave® from Visa, etc.), or another application related to the merchant 102 (or other merchants), the payment network 106, and/or the issuer 108. Or, the internet-based application 122 may relate to other functions used by the consumer 112 and/or to other entities that may interact with the consumer 112. The communication device 116 also includes a signal emitter 124, which may be used, at least, to emit a signal which identifies the communication device 116 to other wireless network devices in the vicinity (e.g., at least one of routers 118a-d, etc.). While only one consumer 112 and one communication device 116 are illustrated in the system 100 of FIG. 1, it should be understood that multiple consumers and/or communication devices may be included in other system embodiments, and perform as described herein.

Further in the system 100, the merchant 102 includes the multiple routers 118a-d. As used herein, the term “router” should be understood broadly to include a variety of different networking devices, which are capable of generating one or more wireless network(s) and/or providing availability to one or more network(s), often wireless network(s). The term “router” should thus be understood broadly to include different routers, switches, gateways, hotspots, modems, adapters, access points, etc. In the system 100, the routers 118a-d each generate and/or make available (i.e., but not necessarily accessible) at least one wireless network having a range, such that when the communication device 116 is within the range, the communication device 116 is able to “see” the wireless network and associate a signal strength with the wireless network. Each of the routers 118a-d is also unhidden, so that each can be recognized by the communication device 116 (even when the communication device 116 is unable to access the wireless network provided thereby). With that said, it should be appreciated that the routers 118a-d may provide networks that are public, private, secured or unsecured. For example, one or more networks provided by the routers 118a-d may be understood to be included in network 110. As such, the merchant 102 and/or the portable communication device 116 may be coupled to network 110, via one or more of the routers 118a-d, so that the one or more networks provided by the routers 118a-d are accessible.

The routers 118a-d are generally included in the merchant 102, as shown in FIG. 1. It should be appreciated, however, that the relative position of the routers 118a-d in the merchant 102 in FIG. 1 is merely illustrative of the general inclusion of the routers 118a-d in the merchant 102, and is not intended to indicate precise relative positions of the routers 118a-d. In addition, in other embodiments the routers 118a-d may be positioned proximate to the merchant 102, or otherwise located, such that at least a part of the wireless network of each of the routers 118a-d overlaps at least a part of the merchant 102, for example, with the cumulative wireless networks then substantially covering the merchant 102.

The position of the routers 118a-d within the merchant 102 (or proximate to the merchant 102) is generally determined in a manner that accounts for ranges of the wireless networks from the routers 118a-d. For example, the routers 118a-d may be disposed within the merchant 102 so that, regardless of where in the merchant 102 the consumer 112 is located, the communication device 116 (associated with the consumer 112) is within the range of at least two or at least three of the routers 118a-d. In this manner, generally, the communication device 116, regardless of its location within the merchant 102, is able to view at least two networks from the routers 118a-d and the signal strength (or intensities) associated with those router networks. It should be understood that the routers 118a-d may be positioned in a variety of different manners, based on a number of criteria, including, without limitation, sizes of merchants, number of floors of the merchants, structural compositions of the merchants, or other criteria that may affect a range of a network provided by such routers 118a-d, etc.

It should be appreciated that one or more of the networks provided by the routers 118a-d may be understood to be included in network 110. As such, the merchant 102 and/or the portable communication device 116 associated with the consumer 112 may be coupled to network 110, via one or more of the routers 118a-d, so that the one or more networks provided by the routers 118a-d may be accessible to the portable communication device 116.

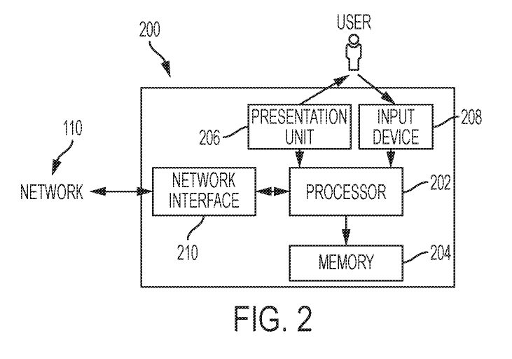

FIG. 2 illustrates an exemplary computing device 200 that can be used in the system 100. The computing device 200 may include, for example, one or more servers, workstations, routers, personal computers, tablets, laptops, smartphones, PDAs, POS devices, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in, computing device 200, coupled to the network 110. In addition, the POS terminal 114 associated with the merchant 102, the portable communication device 116 associated with consumer 112, and the routers 118a-d can also each be considered a computing device consistent with computing device 200 for purposes of the description herein.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, a variety of data structures, zone maps, time series data, reference paths, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information, either visually or audibly to a user of the computing device 200, such as, for example, the consumer 112 at the communication device 116, etc. It should be further appreciated that various interfaces (e.g., as defined by internet-based applications, etc.) may be displayed at computing device 200, and in particular at presentation unit 206, to display such information. The presentation unit 206 may include, without limitation, a liquid crystal display (LCD), a light-emitting diode (LED) display, an LED, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, product entry selections, etc. The input device 208 is coupled to (and in communication with) the processor 202 and may include, for example, a keyboard, a pointing device, a mouse, a button, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, a GPS transmitter, a GPS receiver, combinations thereof (e.g., a GPS transceiver, etc.), or other device capable of communicating to/with one or more different networks, including the network 110. Further, in some exemplary embodiments, the computing device 200 includes the processor 202 and one or more network interfaces 210 incorporated into or with the processor 202. An exemplary network interface 210 is illustrated in FIG. 1 as an emitter 124 of the communication device 116.

Referring again to FIG. 1, the system 100 further includes an offer engine 120. The offer engine 120 is specifically configured, often by computer-executable instructions, to perform one or more of the operations described herein. In the exemplary embodiment, the offer engine 120 is included as a standalone part within the merchant 102, and is generally dedicated to the operations described herein. In addition, the offer engine 120 may be included in, or considered, a computing device consistent with computing device 200. In one or more other embodiments, however, the offer engine 120 may be incorporated into the computing device 200 deployed at the merchant 102, or even in computing devices apart from the merchant 102 (e.g., with the offer engine 120 located external of the merchant 102, etc.), etc.

The offer engine 120 includes a data structure stored in memory 204 of the engine 120, for example, which includes zone maps, time series data, reference paths, etc. In addition, the data structure includes offer content for one or more products. Offer content may include any information about a product, including, for example, its product name, description, price, etc., and may further include information relating to rebates, discounts, deductions, specials, sales (e.g., buy one get one, etc.), or other alterations to the price and/or conditions of sale for the product. Further, offer content may be specific to the merchant 102, and/or to a class, location, category, brand, etc. of products (i.e., non-product specific offer content, etc.), or further still the offer content may be generic among all or substantially all products within the merchant 102, for example. It should be appreciated that the offer content may be disposed in a different data structure, apart from the zone maps, time series data, reference paths, etc., and/or in a different memory included in and/or accessible to the offer engine 120. In at least one embodiment, offer content is provided to the offer engine 120, or retrieved by the engine 120, from a third party (not shown), for example, via an application programming interface (API), whereby offer content for the merchant 102 is able to be controlled at a different and/or centralized location (e.g., at a headquarter office/merchant for multiple common merchants, etc.).

Initially in the system 100, when the consumer 112 and the communication device 116 enter the merchant 102, or are in close proximity to the merchant 102 (or otherwise), as indicated above, the communication device 116 is configured to record signal strengths from the routers 118a-d (typically only upon permission or consent from the consumer 112). As the consumer 112 and the portable communication device 116 move within the merchant 102, the signal strengths for the routers 118a-d, as received at the portable communication device 116, change. For accuracy, the signal records may be captured by the communication device 116 at any regular interval (e.g., about every 0.5 seconds, 1 second, 5 seconds, 20 seconds, 40 seconds, 1 minute, 2 minutes, 5 minutes, etc.) or irregular interval, or based on movement of the communication device 116, or based on one or more other conditions or criteria.

It should be understood that, in an alternative embodiment, the internet-based application 122 on the consumer's communication device 116 (or another application on the consumer's communication device 116) may cause the communication device 116 to emit a signal, for example, via the emitter 124, etc., which includes a unique application identifier (APP ID) identifying the application 122, the communication device 116, and/or the consumer 112 (again, typically only upon permission or consent from the consumer 112). The routers 118a-d then detect the emitted signal from the communication device 116 and the offer engine 120 determines the consumer's 112 location based on emitted signal strengths as detected by each router 118a-d.

Table 1 illustrates exemplary signal strength records for the routers 118a-d, as captured by the communication device 116, for example, when located in, and moving through, the merchant 102. Alternatively, the signal strength records of Table 1 may indicate signal emission intensities measured by the routers 118a-d based on a signal emitted by the communication device 116 at a regular interval. In either case, the signal strength records generally include, at least in the illustrated embodiment, a temporal indicator (e.g., a time and/or date, etc.), a signal intensity for each of the routers 118a-d (including a router identifier), and an application identifier (APP ID). The APP ID is unique to one or more of the web-based applications installed and active in the communication device 116 (e.g., the application 122, etc.), the communication device 116 itself, or the consumer 112. As such, the APP ID can be used by the offer engine 120, as necessary, to identify the consumer 112 and/or the consumer's communication device 116.

TABLE 1

| | | Signal Intensities | | | |
|---|---|---|---|---|---|
| Temporal | APP | Router | Router | Router | Router |
| Indicator | ID | 118a | 118b | 118c | 118d |
| Month/Day/Year | 1 | 0.823502 | 0.332641 | 0.018466 | 0.208735 |
| 11:50 am | | | | | |
| Month/Day/Year | 1 | 0.5264 | 0.603432 | 0.072134 | 0.369233 |
| 11:51 am | | | | | |
| Month/Day/Year | 1 | 0.128009 | 0.938956 | 0.889838 | 0.0744431 |
| 11:52 am | | | | | |
| Month/Day/Year | 1 | 0.880901 | 0.964187 | 0.604075 | 0.904093 |
| 11:54 am | | | | | |

As shown in Table 1, at temporal indicator Month/Day/Year at 11:50 am, the communication device 116 (having APP ID 1) captured signal strengths (or signal intensities) from various routers 118a-d having the values indicated. The communication device 116 then captured additional signal strengths from the same routers 118a-d one minute later, two minutes later, and so on.

After capturing the router signal strength records, the communication device 116 is configured to transmit the captured signal strength records to the offer engine 120, in real-time or near real-time when the records are captured. In response, the offer engine 120 is configured to detect the communication device 116 and receive the signal strength records. The offer engine 120 then stores the signal strength records in memory 204 of the offer engine 120 (e.g., in a data structure associated therewith, etc.).

In certain embodiments, the offer engine 120 is configured to, prior to storing the signal strength records in memory 204, normalize the records to account for differences among different communication devices. In particular, for example, at a given location, the communication device 116 may see signal strengths of {0.1, 0.1, 0.1, 0.1} for routers 118a-d, while a different communication device may see signal strengths of {0.2, 0.2, 0.2, 0.2} for the routers 118a-d at the same location. In order to avoid skewing the signal strengths based on the particular communication device, the offer engine 120 normalizes the signal strength values by multiplying the values by a normalization factor. The normalization factor may be different for each unique communication device or each separate type or brand of communication device. If a communication device emits and/or receives signals at greater strength than the average communication device, the normalization factor may reduce the signal strength values before the values are stored or a communication device location is calculated. Alternatively, if a communication device emits and/or receives signals at lesser strength than the average communication device, the normalization factor may increase the signal strength values before the values are stored or a communication device location is calculated.

Table 2 shows an exemplary set of signal strength data from four separate communication devices, in a single time interval. The four communication devices are each identified by a different unique APP ID, i.e., APP ID 1-4. Signal strength values of signals to/from each of the communication devices, as measured for each of the routers 118a-d, is shown. The signal strength values may be used to locate one or more of the communication devices, as described herein, but because different ones of the communication devices may have different signal emission/reception capabilities, normalization may be necessary and/or desired, as described.

TABLE 2

| | | Signal Intensities | | | |
|---|---|---|---|---|---|
| Temporal | APP | Router | Router | Router | Router |
| Indicator | ID | 118a | 118b | 118c | 118d |
| Month/Day/Year | 1 | 0.0555 | 0.1234 | 0.2569 | 0.3168 |
| 11:50 am | | | | | |
| Month/Day/Year | 2 | 0.4867 | 0.2870 | 0.4380 | 0.5655 |
| 11:50 am | | | | | |
| Month/Day/Year | 3 | 0.2966 | 0.8941 | 0.5806 | 0.2150 |
| 11:50 am | | | | | |
| Month/Day/Year | 4 | 0.7652 | 0.3077 | 0.1440 | 0.4100 |
| 11:50 am | | | | | |

Table 3 includes normalization factors for each of the four communication devices from Table 2. The normalization factor of a particular communication device may be found by comparing the detected intensities with a standard intensity table, which may be established by the merchant 102 when the router arrangement is set up, or by another part of the system 100 associated with providing the router arrangement, etc. A particular normalization factor may be assigned to the particular communication device, or to the particular type of communication device, and stored (e.g., in memory 204 associated with the engine 120, etc.) for later use with that communication device or similar communication devices, when recognized. Communication devices with stronger emission/reception capabilities may be assigned normalization factors of less than one, in order to reduce the detected values down to the standard intensity. Communication devices with weaker emission/reception capabilities may be assigned normalization factors of greater than one, in order to increase the detected values up to the standard intensity.

TABLE 3
Normalization Factors

| APP ID | Factor |
|---|---|
| 1 | 0.8 |
| 2 | 0.8 |
| 3 | 1.1 |
| 4 | 0.9 |

In some embodiments, the standard intensity table may be generated on set up by an employee using a particular communication device as the standard. The employee may move around the merchant 102 with the standard communication device while the routers 118a-d and the offer engine 120 track the location of the communication device. The employee may also enter location data at certain locations within the merchant 102, such that the offer engine 120 may associate the particular set of signal strength intensity values with locations in the merchant 102.

Table 4 shows the intensity values from Table 2 after normalization using the factors of Table 3. Once the values are normalized, they may be used in conjunction with a zone map or coordinate map of the merchant 102 to detect the location of the various communication devices and corresponding consumers. Table 4 also shows exemplary coordinates that correspond with each set of normalized intensities (e.g., relative to a zone map or coordinate map particular to the merchant 102, etc.).

TABLE 4

| | | | Normalized Intensities | | | |
|---|---|---|---|---|---|---|
| APP | x- | y- | Router | Router | Router | Router |
| ID | coord. | coord. | 118a | 118b | 118c | 118d |
| 1 | 19 | 12 | 0.0444 | 0.0994 | 0.2055 | 0.2535 |
| 2 | 23 | 34 | 0.3894 | 0.2296 | 0.3504 | 0.4524 |
| 3 | 26 | 35 | 0.3263 | 0.9835 | 0.6386 | 0.2365 |
| 4 | 11 | 52 | 0.6887 | 0.2769 | 0.1296 | 0.369 |

With that in mind, after detecting the communication device 116 in (or adjacent to) the merchant 102 (in the manner described above), the offer engine 120 is configured to plot a path of the consumer 112 (and in particular, the communication device 116, etc.) within the merchant 102. Specifically, each signal strength record, captured by the communication device 116 and transmitted to the offer engine 120 (and normalized, as necessary), is assigned a zone within the zone map or coordinate map of the merchant 102, based on a relative strength (or intensity) of the signal in the router record, per router 118a-d. In some embodiments, the offer engine 120 calculates coordinates of the communication device 116 and assigns the zone to the communication device 116 based on those coordinates, as the zone map includes a coordinate system for determining location within the merchant 102. Based on this assignment/correlation, the offer engine 120 can determine the particular zones within the merchant 102 in which the consumer 112 was present, and at what times the consumer 112 was present. As the communication device 116 travels from zone A, for example, to zone B, and then on to zone D, and zone E, the offer engine 120 plots the path A-B-D-E. The plot may be simply a zone-to-zone construction (i.e., path A-B-D-E), or it may be representative of the time spend (or linger) in each of the zones. For example, when the consumer spends more time in zone B than in zones A, D, or E, the resulting plot may include the path A-A-B-B-B-B-D-E.

Typically, the zone map associated with the merchant 102 includes multiple zones. Each of the zones is assigned a zone identifier (ID) (e.g., a SF_ID or square-foot ID, etc.) and defines a position of at least one product within the merchant 102. As such, the path of the consumer 112 through the merchant 102, via the various zones, provides an indicator of what products, located within the corresponding zones, the consumer 112 may have viewed or for which the consumer 112 may have interest in purchasing. In some embodiments, the zone map includes a coordinate system for accurately locating consumers and/or products within the zones. Each zone may then be defined by particular sets of coordinates within the coordinate system. A zone may include a single coordinate combination of the merchant 102, and the coordinate combination may be associated with one or more products at that location based on UPC, SKU, etc. of the products or other identifying information, for example.

The zone map may be defined within the merchant 102 using an app which is in communication with the routers 118a-d and the offer engine 120. Signal strengths from the routers 118a-d can be used to establish the zone map (e.g., to a granularity of about one foot, etc.). An employee may use a communication device running the app to scan UPC codes of items or otherwise enter item information (e.g., SKU codes, etc.) while the communication device is in the location where the item will be on display. Signal strength values of a signal to/from the routers 118a-d are gathered when the item information is entered and the offer engine 120 associates the item with the location defined by the signal strength values in the zone map. If items are moved or reorganized, a store employee can rescan the item in the new location, causing it to be associated with the new location.

The offer engine 120 is also configured to access historical transaction data for the consumer 112 (as determined from the unique APP ID) in connection with providing offer content to the consumer 112. Additionally or alternatively, the offer engine 120 may also access historical transaction data for one or more demographic groups to which the consumer 112 may belong. In connection therewith, the offer engine 120 is configured to identify offer content for the consumer 112 based on the historical transaction data. Such offer content may be based on the transaction data for the consumer 112 alone, or together with one or more of the positions of the consumer 112 in the merchant 102, the plotted path of the consumer 112 through the merchant 102, a condition of the consumer's plotted path (e.g., a linger condition, etc.), and/or a comparison of the consumer's plotted path to a reference path (e.g., a path for the consumer 112 for a prior visit to the merchant 102, or a path for a different consumer at the merchant 102, etc.), etc. (broadly, based on offer identification conditions). In other words, the consumer's personal transaction history and/or the transaction history of other consumers, generally, may be used in combination with, or in place of, the location data of the consumer 112 in the merchant 102.

As an example, if consumer 112 is lingering in a particular position in the merchant 102 for five to ten minutes, the offer engine 120 may assume that the consumer 112 is interested in a product or products near the location. In order to identify a “best fit” offer, the offer engine 120 may consider merchant revenue, profit margin, consumer loyalty, and/or price sensitivity, etc. If consumer 112 has a purchase history that indicates strong brand loyalty, the offer engine 120 may provide an offer that is of the consumer's favorite brand for a product or products near the location. Alternatively, if the consumer 112 has a purchase history that shows a high price sensitivity, the offer engine 120 may offer a discount on an item near the consumer's location or provide a similar item which costs less. Each factor may be considered by the offer engine 120 alone or in combination with some or all of the other factors.

Further, paths of consumers through merchant 102 may be tracked based on aggregated historical location data and, when combined with historical transaction data, paths which more often result in sales may be discovered (e.g., and used as potential reference paths, etc.). This general historical path data, as well as path data specific to the consumer 112, may be used to provide offers to consumer 112 as he or she moves about the merchant 102. Historical paths may indicate items that are often browsed together or in succession and predictions may be made, by the engine 120, based on such trends and/or patterns regarding where the consumer 112 will go next. Additionally, the historical path data may be used by the merchant 102 to determine organization of the merchant 102 and where products should be placed on the shelves to maximize sales.

What's more, from aggregated path information of all consumers, the offer engine 120 (and/or the merchant 102) may also identify what are most popular paths that lead to a particular product sale (e.g., and use them as potential reference paths, etc.). The offer engine 120 (and/or the merchant 102) also can identify what products are purchased together by consumers by product basket analysis (e.g., at checkout, etc.), which may help the merchant 102 locate and organize products.

In addition, the offer engine 120 may make use of responses to previously chosen offers to improve future offer choices. In order to make use of the historical offer data, the offer engine 120 may use statistics and machine learning applied to the historical offer data. The offer engine 120 observes historical offer data from within the merchant 102 across many consumers in order to determine a ‘best fit” optimized offer at a given time and place for a particular consumer, for example, consumer 112. If an offer in the store frequently results in the offered consumer purchasing the item, that offer may be more likely to be offered to a future consumer. Alternatively, if an offer rarely results in a consumer purchasing the item, it may be seen as a non-optimal offer for most future consumers.

Further, the offer engine 120 may identify offers based on products included in an electronic shopping cart associated with the consumer 112 or based on products viewed by the consumer 112 at the consumer's portable communication device 116 (again, typically only upon permission or consent from the consumer 112), and provide the offers based, at least in part, thereon. Still further, and as described above, the offer engine 120 may track prior discount offers provided to the consumer 112 and use, or not, of the offers by the consumer 112 (e.g., via suitable identifiers included in the offers such as barcodes, etc.) to determine redemption tendencies of the consumer 112. Here, future offers to the consumer 112 may then be tailored to the consumer 112 based on the consumer's past redemption tendencies.

As can be seen, the path of consumers through the merchant 102, as well as other factors such as transaction history for the consumers, prior offer redemption, etc., can be used to determine buying propensities for the consumers. Using such factors, the offer engine 120 may optimize product offers for each of the consumers and, in some embodiments, provide offers with a priority hierarchy based on quality and magnitude of the consumers to make certain purchases, follow certain paths, etc. For example, real time behavior (e.g., lingering, actual path, etc.) of consumer 112 may have the highest quality and a highest propensity for product A. However, if there is no high propensity product near the lingering actions of consumer 112, the application 122 at the consumer's communication device 116, via the offer engine 120, may defer to other factors such as the consumer's transaction history (and/or other propensities) to find nearby products that the consumer 112 may desire to purchase. If the consumer 112 does not have a transaction history or other available propensities, the application 122 would defer to generic purchase propensities built on paths of past customers (e.g., reference paths, etc.) to determine to which product the consumer's current path typically leads.

Thus, in various implementations, the offer engine 120 combines (or aggregates) different ones of the above factors (or others) to provide an individualized offer to each consumer. As such, for each consumer, the combination of factors may be different and the balance of factors to decide an optimum offer may also be individualized. In addition to the aggregated level, for individual consumers having paths of travel close to the most popular sale paths (e.g., reference paths, etc.) for a sub set of products, the sub set of products may be the candidates for the given individual consumer. With other information, the offer engine 120 may learn and filter out many products from the subset by price, brand, purchase frequency, and so on, and finally narrow down to a few particular products for offers. As noted above, by combining store revenue and profit consideration, a suitable offer can then be generated for the particular consumer.

Once the offer content is identified, the offer engine 120 is configured to cause the content to be displayed to the consumer 112, at the consumer's communication device 116 (e.g., at the presentation unit 206, etc.). The offer engine 120 is configured to then determine if the offer, associated with the displayed offer content, is (or has been) accepted by the consumer 112 (e.g., by monitoring transaction data for the consumer 112, by receiving a consumer selection/input of the offer via the communication device 116, etc.). The offer engine 120 is further configured to then modify one or more of the conditions by which the offer engine 120 identifies the offer content (i.e., the offer identification conditions), thereby providing feedback to the offer content displayed to the consumer 112 relative to the consumer's plotted path through the merchant 102.

While specific configurations of the offer engine 120 (e.g., as computing device 200, etc.) are indicated above, it should be appreciated that the engine 120 is further configurable consistent with the operations described below with regard to method 300. In addition, reference is also made herein to Applicant's co-pending US application titled “Systems and Methods for use in Determining Product Positions within Shopping Regions,” filed on the same day as the instant application, and Applicant's co-pending US application titled “Systems and Methods for use in Determining Detailed Locations for Certain Entities,” also filed on the same day as the instant application, both of which are incorporated herein by reference in their entireties.

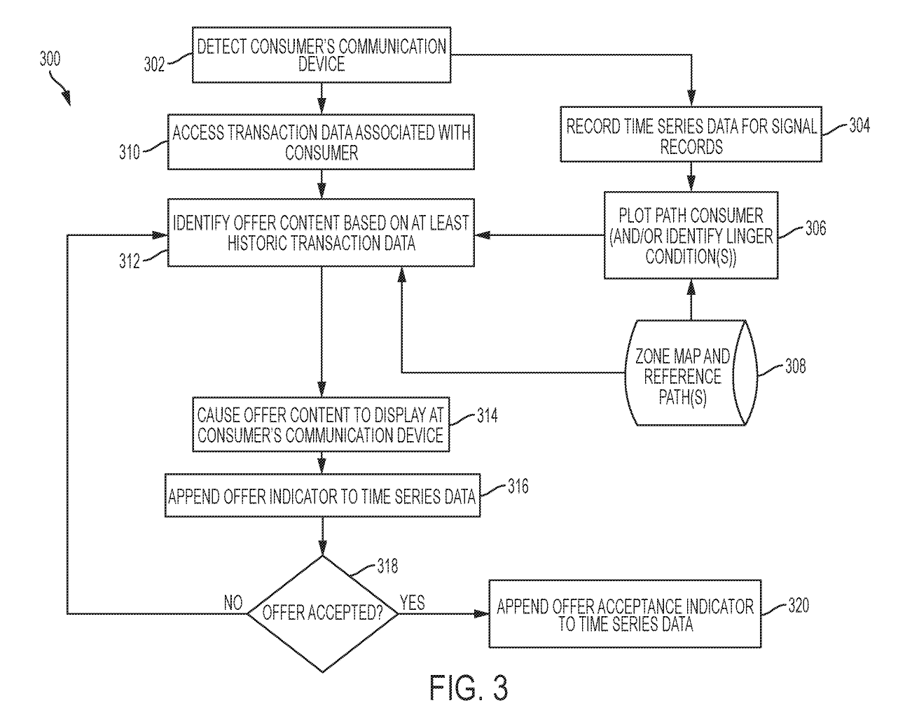

FIG. 3 illustrates an exemplary method 300 for use in directing offer content to a consumer while the consumer is at a merchant location. The method 300 is described with reference to the system 100, and in particular, as operations of the portable communication device 116 and the offer engine 120. It should be appreciated, however, that the methods described herein are not limited to the system 100. And, conversely, the systems described herein are not limited to the exemplary method 300.

As described above, when the consumer 112 and the communication device 116 enter the merchant 102, or are in close proximity to the merchant 102 (or otherwise), the communication device 116 captures signal strength records from the routers 118a-d and transmits the records to the offer engine 120. Alternatively, the routers 118a-d capture signal strength records from signals being emitted by the communication device 116, by the emitter 124, and transmit the records to the offer engine 120. As the consumer 112 and the portable communication device 116 move within the merchant 102, the router signal strengths for the routers 118a-d, as received at the portable communication device 116, change and are further transmitted to the offer engine 120. For accuracy, the signal records may be captured by the communication device 116 at any regular interval (e.g., about every 0.5 seconds, 1 second, 5 seconds, 20 seconds, 40 seconds, 1 minute, 2 minutes, 5 minutes, etc.) or irregular interval, or based on movement of the communication device 116, or based on one or more other conditions or criteria.

In response, the offer engine 120 receives the signal strength records and detects the consumer's communication device 116, at 302. The offer engine 120 then stores the signal strength records in memory 204 of the offer engine 120. In connection therewith, the offer engine 120 also records time series data for the received signal strength records, at 304, in connection with the communication device 116.

Next, at 306, the offer engine 120 plots the path of the consumer 112 (and in particular, the communication device 116) through the merchant 102 based on the signal strength records (and/or the time series data generated therefrom). In particular, the offer engine 120 retrieves a zone map from data structure 308 (e.g., stored in memory 204 of the offer engine 120, etc.) and identifies a zone within the zone map corresponding to the signal strengths included in the signal strength records. Then, the offer engine 120 compiles the time series data generally in a consistent format. For example, and without limitation, the offer engine 120 may compile the time series data in a format such as {APP ID, Time ID, square-foot ID (SF_ID (or zone), offer indicator (Offer_ID), response indicator (Response_ID)}, etc. With that said, it should be appreciated that other formats of the time series data may be recorded and stored in memory 204, by the engine 120.

Also at 306, the offer engine 120 identifies one or more linger conditions from the signal strength records and/or time series data. Such linger conditions may include receipt of multiple signal strength records from the same zone within the merchant 102, indicating that the consumer 112 may have stopped and/or otherwise lingered within the zone of the merchant 102 looking at particular products within the zone (and thereby suggesting that the consumer 112 may have an interest in the products included in the zone).

Table 5 illustrates an exemplary data structure including time series data entries for example signal strength records received by the offer engine 120 from the consumer's communication device 116 or from the routers 118a-d, as appropriate. In this example, the signal records are received every 5 seconds, although it should be understood that the signal strength records may be received at different rates (e.g., every 0.1 seconds, every 1 second, every minute, etc.) in other embodiments. For illustration, the time series data is included in the data structure in the format {APP ID, Time ID, square-foot ID (SF_ID (or zone), offer indicator (Offer_ID), response indicator (Response_ID)}, as indicated above.

TABLE 5

| APP ID | Time ID | SF_ID | Offer_ID | Response_ID |
|---|---|---|---|---|
| 1 | 1 | 11 | | |
| 1 | 2 | 12 | | |
| 1 | 3 | 12 | | |
| 1 | 4 | 12 | 4 | |
| 1 | 5 | 14 | | |
| . | . | . | . | . |
| . | . | . | . | . |
| . | . | . | . | . |
| 1 | 25 | 19 | | 4 |

In this example, in connection with plotting a path of the consumer 112 through the merchant 102 (at 306 in method 300, for example), the offer engine 120 uses the SF_ID to plot a path 11-12-12-12-14 . . . 19. In addition, the offer engine 120 identifies (at 306 in method 300, for example) that the consumer 112 lingers in SF_ID 12 for three signal records entries, which, in this exemplary embodiment, includes 15 seconds. The amount of time that constitutes “lingering” for the purposes of the offer engine 120 providing offers to a consumer may be defined by each individual merchant and may be a time interval of nearly any length (e.g., 15 seconds, 30 seconds, 1 minute, 5 minutes, 10 minutes, etc.). As noted above, the linger time for the consumer 112 may be a factor used in determining an interest level for the consumer in a product, etc. In fact, in this example, as shown in Table 5, an offer associated with Offer_ID 4 was transmitted to the consumer 112 following such lingering.

With continued reference to FIG. 3, separately in the method 300, the offer engine 120 accesses transaction data for the consumer 112, at 310. In so doing, the offer engine 120 identifies consumer 112 from the APP ID (e.g., as APP ID 1 in the above example, etc.), and then accesses the transaction data for the identified consumer 112 from the payment network 106 and/or from memory 204 at the merchant 102, for example. In connection with this operation of the method 300, the offer engine 120 may access all available transaction data for the consumer 112. Or, the offer engine 120 may access transaction data for the consumer 112 for a particular time period, and/or for particular categories of transactions, etc. In some embodiments, if the payment ID of the consumer 112 is not linked with the App ID of the consumer's device, the offer engine 120 may determine the link between the payment ID and the App ID based on historical location data and historical transaction data for the consumer 112. For example, the offer engine 120 may use location information (e.g., App_ID, time, x-coordinate(s), y-coordinate(s), combinations thereof, etc.) for the consumer 112 and payment information (e.g., time, x-coordinate(s), y-coordinate(s), itemized transaction amount(s), product UPC, combinations thereof, etc.). In this example, the consumer's x-coordinate(s) and y-coordinate(s) at the given time are the same as the consumer's payment location at the same time.

Then, at 312, the offer engine 120 identifies offer content for the consumer 112 based on the transaction data, together with the plotted path of the consumer 112 through the merchant 102 (e.g., path 11-12-12-12-14 . . . 19 in the above example, etc.) and any identified linger conditions for the consumer 112 (e.g., a fifteen second linger condition for the consumer in zone 12 in the above example, etc.). In doing so, the offer engine 120 may retrieve one or more prior reference paths from the data structure 308 for comparison to the consumer's plotted path. As described above, the reference paths may include a previous plotted path for the consumer 112 for a prior visit to the merchant 102, or a previous plotted path for a different consumer at the merchant 102. It should be appreciated that other factors may also be considered in combination with the consumer's path when identifying offer content, such as store revenue, profit margin, consumer loyalty, price sensitivity, historical behavior patterns of the consumer 112, similar patters from other consumers (e.g., similar reference paths, etc.), etc.

Once the offer content is identified, the offer engine 120 causes the offer content to be displayed to the consumer 112 at the consumer's communication device 116 (e.g., at the presentation unit 206 thereof, etc.), at 314. Such operation is often accomplished by the offer engine 120 through interaction with the internet-based application installed and/or active at the consumer's communication device 116. In addition, and at about the same time (or earlier or later), the offer engine 120 appends an offer content indicator for the identified offer content to the time series data previously recorded, at 316. In the above time series data example, illustrated in Table 5, an offer indicator (or Offer ID) of “4” is appended thereto at Time ID 4, as corresponding to a particular discount offer for the consumer 112 made at Time ID 4.

The offer engine 120 then determines, at 318, if the offer is (or has been) accepted by the consumer 112. For example, the offer engine 120 may monitor transaction data for the consumer 112 for transactions involving the offer, or may receive a particular consumer selection/input of the offer via the consumer's communication device 116, etc. In any case, when the offer is accepted by the consumer 112, the offer engine 120 appends an offer acceptance indicator for the identified offer content to the time series data previously recorded, at 320. Again, in the above time series data example illustrated in Table 5, a response indicator (or Response ID) of “4” is appended thereto at Time ID 25, as corresponding to acceptance of the particular discount offer by the consumer 112 at Time ID 25. Otherwise, the offer engine 120 repeats operations 312-318, for as long as the consumer 112 is present at the merchant 102 (and the offer engine 120 detects the consumer's communication device 116).

In some embodiments, the response indicator may include multiple values that indicate the behavior of the consumer 112. A first value may identify an offer provided as described above, while a second value may indicate response of the consumer 112 to the offer. For instance, the offer identifier of “4” may be appended to indicate that offer 4 was provided to the consumer 112, and a further value of −1 may be appended with the “4” if the consumer 112 responded negatively (e.g., walked the other direction from the item, etc.) to the offer. If the offer engine 120 cannot determine a consumer response, a value of 0 may be appended. For positive responses, positive values may be appended based on degree of response (e.g., a positive 1 for the consumer approaching the item in response to the offer, a positive 2 if the consumer lingers near the product, etc.).

In view of the above, the systems and methods herein provide intelligent selection of offer content for consumers, which may be specific to the consumers based on prior transaction history, the consumers' locations, and/or the consumers' paths in or among merchants. In this manner, offer content is delivered to the consumers close in time to when the consumers are making decisions whether or not to purchase products such that the potential for accepting the offer content and/or purchasing the products, to which the offer content is related, is increased as compared to delivery of the offer content at other times.

While wireless (Wi-Fi and Bluetooth) signals from the routers 118a-d are used in the system 100 and method 300 to identify locations within the merchant 102, it should be appreciated that in other embodiments GPS signals may be used. However, in use of such GPS signals, location data may not be as granular or accurate as the location data based on the wireless signals described.

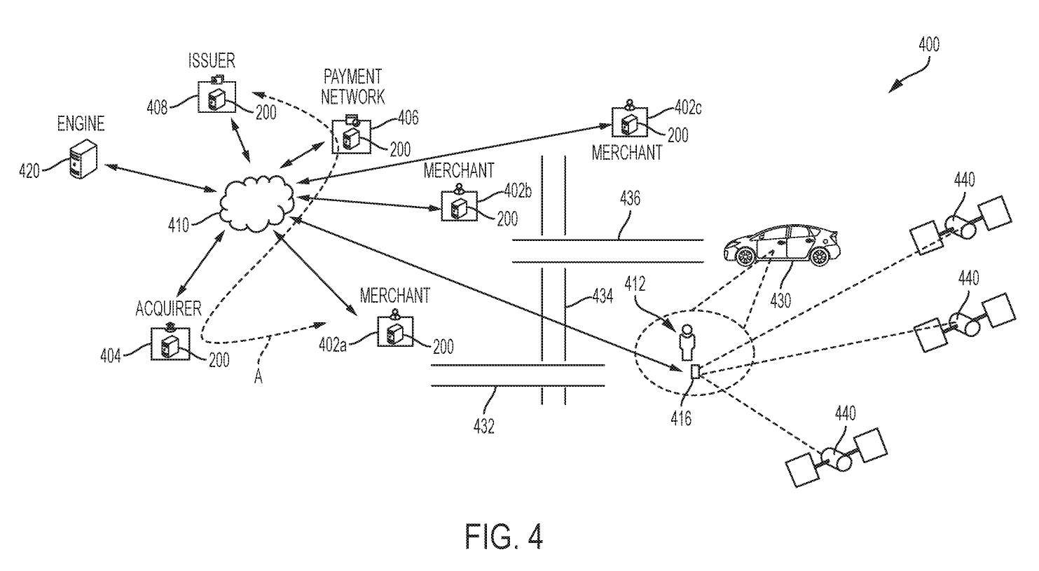

With that said, FIG. 4 illustrates another exemplary system 400, in which one or more aspects of the present disclosure may be implemented. The system 400 is similar to the system 100 previously described and illustrated in FIG. 1, in that positions of products and consumers within merchant locations can be provided/determined so that merchants can direct offer content to the consumers when the consumers are ready to purchase products or can easily access the corresponding merchants. In this embodiment, however, GPS signals are used to identify the positions of the products and/or the consumers within merchant locations, rather than wireless signals. Merchant locations may include single merchants (e.g., department stores, etc.), or groupings of multiple merchants (e.g., at shopping centers such as malls; within geographic locations such as business districts, downtown areas, etc.; etc.)

As shown in FIG. 4, the system 400 generally includes merchants 402a-c, an acquirer 404, a payment network 406, and an issuer 408, each coupled to network 410. Each of the merchants 402a-c, the acquirer 404, the payment network 406, and the issuer 408 in the system 400 is also illustrated as including, or being implemented in, computing device 200 coupled to (and in communication with) the network 410. It should be appreciated that these parts of the system 400 are substantially the same as the corresponding parts previously described for the system 100 (e.g., the merchant 102, the acquirer 104, the payment network 106, the issuer 108, and the network 110). As such, the prior descriptions of these parts also apply for the system 400.

The system 400 also includes an offer engine 420 configured, often by computer-executable instructions, to specifically perform one or more of the operations described herein. The offer engine 420 is substantially the same as the offer engine 120 previously described for the system 100 and, thus, is configured to perform similar or the same operations. As such, it should be appreciated that the previous description of the offer engine 120 also applies for the offer engine 420.

In addition in the system, consumer 412 is associated with communication device 416. The communication device 416 is configured (typically upon permission or consent from the consumer 412) to receive GPS signals from satellites 440 (e.g., via network interface 210, etc.). For example, the communication device 416 may include an internet-based application (e.g., a navigation application, a map application, etc. known to those skilled in the art) that, upon receipt of the GPS signals (e.g., from all three satellites 440, etc.), enables the communication device 416 to calculate a position of the communication device 416 (and thus, the consumer 412). The communication device 416 may also be configured to relate the calculated position, for example, to positions of the merchants 402a-c (e.g., via the internet-based application, etc.). For accuracy, the GPS signals from the satellites 440 may be captured by the communication device 416 at any regular interval (e.g., about every 0.5 seconds, 1 second, 5 seconds, 20 seconds, 40 seconds, 1 minute, 2 minutes, 5 minutes, etc.) or irregular interval, or based on movement of the communication device 416, or based on one or more other conditions or criteria. In some implementations of the system 400, the communication device 416 may also be configured to transmit location data, as desired.

In this embodiment, the merchants 402a-c are arranged in a merchant location illustrated as a generally common geographic location (e.g., a business district, etc.), each accessible to consumer 412, for example, by traveling in vehicle 430 along one or more roadways 432-436. As the consumer moves along one of the roadways 432-436, the communication device 416 receives GPS signals from the satellites 440 and determines a current position for the device 416 relative to the merchants 402a-c (and any other merchants in the geographic location), via the internet-based application. In turn, the communication device 416 is configured to transmit the captured GPS signals, as GPS records, to the offer engine 420, in real-time or near real-time when the records are captured (e.g., via network 410, etc.). In response, the offer engine 420 is configured to detect the communication device 416 and receive the GPS records. The offer engine 420 then stores the records in memory 204 of the offer engine 420 (e.g., in a data structure associated therewith, etc.), in similar fashion to that described for the offer engine 120 (and the signal strength records received thereby). Alternatively, the communication device 416 may be configured to transmit an actual position to the offer engine 420, as determined by the internet-based application.

After detecting the communication device 416 in (or adjacent to) the merchant location (in the manner described above), the offer engine 420 is configured to plot a path of the consumer 412 (and in particular, the communication device 416, etc.) within the merchant location, for example, along the roadways 432-436, etc. For example, based on the GPS records received from the communication device 416, the offer engine 420 may determine a particular zone within the merchant location in which the consumer 412 is present (or was previously present), and corresponding times for which the consumer 412 was in the particular zone(s), in similar fashion to that described for the offer engine 120. In so doing, the offer engine 420 knows generally where the consumer 412 is at any given time, when at the merchant location.

The offer engine 420 is also configured to access historical transaction data for the consumer 412, in a similar manner to that described for the offer engine 120. For example, the offer engine 420 may be configured to identify the consumer 412 from a unique APP ID transmitted by the communication device 416 to the offer engine 420 when transmitting the GPS signals. The offer engine 420 may then access desired transaction data, for example, from the payment network 406, etc., for use as described herein. Additionally or alternatively, the offer engine 420 may also access historical transaction data for one or more demographic groups to which the consumer 412 may belong.

The offer engine 420 is configured to then identify offer content for the consumer 412, based on the plotted path of the consumer 412 and the historical transaction data, in similar fashion to the above description for the offer engine 120. And, once identified, the offer engine 420 is configured to direct the offer content to the consumer 412, via the communication device 416. The consumer 412 can then select, or not, the offer content. When selected, the communication device 416, via the internet-based application installed thereon, may direct the consumer 412 to the location associated with the offer content.

The offer content identified by the offer engine 420 may relate to any of the merchants 402a-c and/or to any of the products offered for sale by the merchants 402a-c. Or, the offer content may be filtered, based on preferences provided by the consumer 412 to the offer engine 420 (e.g., via settings in the internet-based application used by the consumer 412 at the communication device 416, etc.). For example, the consumer 412 may provide a preference to the offer engine 420 restricting offer content to particular ones of the merchants 402a-c, or to ones of the merchants 402a-c within a predefined distance of the consumer 412 (e.g., within one mile, within 0.5 miles, etc.). Additionally, or alternatively, the consumer 412 may provide a preference to the offer engine 420 for a particular type (and/or brand) of product.

In some embodiments, in connection with identifying offer content for the consumer 412, the offer engine 420 may access a listing of favorite products (or recently viewed products) at the communication device 416, and then filter the offer content based thereon. For example, the offer engine 420 may send all offers to the consumer 412 relating to the consumer's favorite products when one or more of the merchants 402a-c offers the products for sale, and the consumer 412 is within a predefined range of the merchants 402a-c. In addition, in some embodiments, when the consumer 412 elects to do so, the communication device 416, as configured by the internet-based application, permits the consumer 412 to request (e.g., to search for, etc.) a product, by name, brand, category, or otherwise, etc. Then, when the consumer 412 is within a predefined range of a merchant selling the product (e.g., one of the merchants 402a-c, etc.), or within a geographic location specified by the consumer 412 (e.g., specific latitude and longitude coordinates provided by the consumer 412, etc.), etc., the offer engine 420 identifies appropriate offer content to transmit to the consumer 412.

With that said, in various exemplary embodiments herein, the consumer (e.g., the consumer 112, the consumer 412, etc.) can select whether or not to transmit, or otherwise share, location data with the offer engine (e.g., with the offer engine 120, the offer engine 420, etc.). For example, the consumer's communication device (via the appropriate internet-based application) may only communicate with the offer engine upon receiving permission or consent from the consumer. In addition, in various embodiments herein, the consumer may even selectively activate or deactivate the offer engine, for example, at the consumer's communication device.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) detecting an application identifier associated with a communication device at or near a merchant location; (b) receiving signal strength records from the communication device, where each signal strength record is indicative of signal strengths for at least two wireless networking devices at a given time and associated with the application identifier; (c) accessing a zone map associated with the merchant location, where the zone map includes at least a first zone and a second zone, each of the first and second zones assigned a zone ID and defining a position of at least one product; (d) plotting a path of the communication device, per given time, relative to the zone map; and (e) when the path indicates a linger condition in the first zone, causing an offer associated with the at least one product of the first zone to be displayed at the communication device.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in directing content to a communication device, the method comprising:
detecting, by a computing device, an application identifier associated with a communication device at or near a merchant location;
receiving, by the computing device, signal strength records, each signal strength record indicative of signal strengths between the communication device and at least two wireless networking devices at a given time and associated with the application identifier;
accessing a zone map associated with the merchant location, the zone map including at least a first zone and a second zone, each of the first and second zones assigned a zone ID and defining a position of at least one product;
plotting a path of the communication device, per given time, relative to the zone map; and
when the path indicates a linger condition in the first zone, causing an offer associated with the at least one product of the first zone to be displayed at the communication device.

2. The computer-implemented method of claim 1, wherein plotting the path includes generating time series data for the communication device over the given time, the time series data including multiple time series entries; and
wherein causing the offer to be displayed includes appending an offer ID to one of the time series entries associated with the communication device, the offer indicative of the at least one product.

3. The computer-implemented method of claim 2, wherein the period between time series entries is between about 0.1 seconds and about 1 second; and
wherein the linger condition includes at least 150 consecutive time series entries indicating the first zone.

4. The computer-implemented method of claim 3, further comprising appending a response ID to one of the time series entries associated with the communication device, when a consumer associated with the communication device accepts the offer.

5. The computer-implemented method of claim 1, further comprising selecting the offer for the at least one product, from multiple products positioned within the first zone, based on at least one of a transaction history for a consumer associated with the communication device and a demographic associated with the consumer.

6. The computer-implemented method of claim 1, further comprising selecting the offer based on a reference path associated with at least one different communication device and/or said communication device at a prior attendance at the merchant location.

7. The computer-implemented method of claim 1, further comprising normalizing each of the signal strengths.

8. The computer-implemented method of claim 1, further comprising causing the offer to be displayed at the communication device, when the path correlates to at least one reference path.

9. The computer-implemented method of claim 1, further comprising:
emitting signals by the at least two wireless networking devices;
receiving the signals by the communication device; and
transmitting, by the communication device, signal strength records to the computing device.

10. The computer-implemented method of claim 1, further comprising:
emitting signals by the communication device;
receiving signals by the at least two wireless networking devices; and
transmitting, by the at least two wireless networking devices, signal strength records to the computing device.

11. An offer engine system for providing targeted information to a communication device, the offer engine system comprising:
a processor;
a network interface in communication with the processor;
at least one memory device in communication with the processor, the at least one memory device including processor-executable instructions which, when executed by the processor, cause the processor to:
receive signal strength records via the network interface, each signal strength record indicative of signal strengths between a communication device and at least two wireless networking devices in a merchant location at a given time;
access a coordinate map associated with the merchant location, the coordinate map including at least a first zone and a second zone, each of the first and second zones assigned at least a set of coordinate pairs and defining a position of at least one product;
locate the communication device on the coordinate map based on the received signal strength records; and
when a location of the communication device indicates a coordinate pair in the first zone, causing an offer associated with the at least one product of the first zone to be transmitted to the communication device.

12. The offer engine system of claim 11, wherein the signal strength records are received from the at least two wireless networking devices.

13. The offer engine system of claim 11, wherein the signal strength records are received from the communication device.

14. The offer engine system of claim 11, further comprising processor-executable instructions which, when executed by the processor, cause the processor to:
record multiple locations of the communication device on the coordinate map;
plot a path of the communication device based on the multiple recorded locations; and
select the offer associated with the at least one product, from a plurality of products, to be transmitted to the communication device based, at least in part, on the plotted path of the communication device.

15. The offer engine system of claim 11, further comprising processor-executable instructions which, when executed by the processor, cause the processor to:
access historical transaction data from the at least one memory device; and
select the offer associated with the at least one product, from a plurality of products, to be transmitted to the communication device based, at least in part, on the historical transaction data.

16. The offer engine system of claim 15, wherein the historical transaction data includes previous purchases for a consumer associated with the communication device.

17. The offer engine system of claim 15, wherein the historical transaction data includes previous purchases associated with at least one demographic for a consumer associated with the communication device.

18. A non-transitory computer-readable storage media comprising processor-executable instructions which, when executed by at least one processor, cause the at least one processor to:
receive signal data indicative of a position of a communication device at a merchant location at a given time;
access a coordinate map associated with the merchant location, the coordinate map defining a position of at least one product in the merchant location;
locate the communication device on the coordinate map based on the received signal data; and
when the position of the communication device indicates a coordinate pair in proximity to the at least one product, causing an offer associated with the at least one product to be transmitted to the communication device.

19. The non-transitory computer-readable storage media of claim 18, further comprising processor-executable instructions which, when executed by the at least one processor, cause the at least one processor to:
access transaction data associated with previous purchases at the merchant location; and
select the offer associated with the at least one product, from a plurality of products, to be transmitted to the communication device based, at least in part, on the transaction data associated with previous purchases at the merchant location.

20. The non-transitory computer-readable storage media of claim 19, further comprising processor-executable instructions which, when executed by the at least one processor, cause the at least one processor to:
monitor purchases at the merchant location after causing the offer to be transmitted to the communication device; and
record transaction data of a purchase associated with the communication device, the transaction data including an indicator of offer success when the purchase includes the at least one product with which the transmitted offer is associated and an indicator of offer failure when the purchase does not include the at least one product with which the transmitted offer is associated.
